(19) United States
(12) Patent Application Publication
(10) Pub. No.: US 2012/0324325 A1
(43) Pub. Date: Dec. 20, 2012

(54) Patent Prosecution Accelerator Package

(76) Inventor: Donald R. Boys, Aromas, CA (US)

(21) Appl. No.: 13/162,919

(22) Filed: Jun. 17, 2011

(51) Int. Cl. G06F 3/14

(52) U.S. Cl. 715/205

(57) ABSTRACT

A package of digital files for patent prosecution contains an office action (OA) dedicated to a specific case in examination by a patent examination authority, the OA displayable in a display window coupled to a computerized appliance, and a first reference document also displayable in the same or a separate window. The OA comprises a statement alleging a portion of the first reference document as teaching or suggesting a limitation of a claim in examination in the specific case, and a word or phrase in the statement is implemented as a hyperlink to the portion of the first reference document alleged as teaching or suggesting the limitation of the claim, such that activating the link in a window on the display monitor displays the first reference document at a place at or near the portion alleged as teaching the limitation.

### BACKGROUND OF THE INVENTION

1. Field of the Invention

The present invention is in the technical area of software system and pertains more particularly to systems for reducing workload for patent practitioners in responding to Office Actions.

2. Description of Related Art

The process of patent examination and responding to office actions in patent examination is well-known. Patent applications include claims that recite what the inventor(s) consider to be patentable subject matter. It is a responsibility of a patent examination authority in a legal jurisdiction like the United States or Japan to search for prior art reading on limitations of standing claims in an application, and for an examiner to which a case is assigned by the authority to render judgment on whether, in the examiner's opinion, portions of references found in search read on one or more limitations of standing claims. These opinions and judgments are typically presented in a document termed in art an Office Action (OA).

An OA is typically issued to a correspondence address listed for an inventor or a law firm, and the inventor or a registered practitioner of the law firm is responsible for preparing a response to the OA within a prescribed time period, which varies by jurisdiction. A respondent may amend claims within scope enabled by an original disclosure, and may take issue with an examiner's rejections and rationale for rejection.

Given an issued OA, it falls to the inventor or a practitioner representing the inventor or inventors to read and analyze the OA and referenced documents, and to prepare a suitable response. OAs are typically sent as hard copy documents to a correspondence address, and include a listing of references cited and applied; applied meaning that a particular reference is alleged as having a portion teaching or suggesting a limitation in a standing claim. Copies of the references themselves are not sent along with the OA. US OAs may also be down loaded from the PAIR database of the United States Patent and Trademark Office (USPTO) or other patent authority where pertinent. References are typically not available for download at an authority's site.

To prepare a proper response, the person responsible, or other persons in support, must acquire the applied references, and for some purposes references cited by an examiner and not applied, so the examiner's allegations may be studied pending decisions on how to amend claims or how to dispute an examiner's allegations. Then the decisions have to be implemented to prepare a formal reply brief to the outstanding OA.

Skilled persons familiar with the examination and response process are aware that much of the work toward making the relevant decisions and preparing a suitable response is support work that may be done by support persons and provided to a highly skilled and experienced patent practitioner to finish the response. For example, it is not cost-effective for a highly-paid patent attorney to search on the Internet for references, and to download the references, and in some cases to render the references as machine-readable so portions may be readily easily copied into narrative of a response. It is generally desirable that the activity of the highly experienced practitioner be reserved for making the relevant decisions, amending claim as necessary and authoring the text of a response brief.

What is clearly needed is a process that results in a package of relevant documents presentable in such a way that a practitioner may quickly and with focus review every allegation by an examiner in an OA, to make decisions relating to needed amendments and response arguments, and implement the decisions in preparing the response.

### BRIEF SUMMARY OF THE INVENTION

A package of digital files for patent prosecution is provided, the package resident on a memory device coupled to a computerized appliance. The package includes an office action (OA) issued by a patent examination authority, the OA dedicated to a specific case in examination by the patent examination authority, the OA implemented as a machine-readable digital file displayable in a window on a display monitor coupled to the computerized appliance, and a first reference document implemented as a machine-readable digital file also displayable in the same or a separate window on the display monitor. The OA comprises a statement alleging a portion of the first reference document as teaching or suggesting a limitation of a claim in examination in the specific case, and a word or phrase in the statement is implemented as a hyperlink to the portion of the first reference document alleged as teaching or suggesting the limitation of the claim, such that activating the link in a window on the display monitor displays the first reference document at a place at or near the portion alleged as teaching the limitation.

In one embodiment the OA is displayed in a first window and the first reference document is displayed in a separate, second window, such that the first window remains open displaying the OA when the link is initiated displaying the first reference document in the separate, second window. Also in one embodiment the OA comprises multiple statements alleging a portion of the first reference document as teaching or suggesting different limitations in one or more claims in examination in the case, and hyperlinks from portions of different ones of the multiple statements to the portions of the first reference document alleged as teaching or suggesting a limitation.

In another embodiment the OA comprises multiple statements alleging a portion of the first reference document and portions of one or more second reference documents as teaching or suggesting different limitations in one or more claims in examination in the case, and hyperlinks from portions of different ones of the multiple statements to the portions of the reference documents alleged as teaching or suggesting a limitation. Also in an embodiment there may be a a text-editable document having a list of the claims in examination, the claims editable to amend the language recited in the claims, and portions of the document indicated for a user to compose responses to the allegations in the OA. The text-editable document may include a heading page stating at least the Case Serial Number, an examiner, and the art unit. In one embodiment the OA is issued by the United States Patent and Trademark Office.

In another aspect of the invention a method facilitating response to an Office Action (OA) issued by a patent examining authority in a specific case under examination by the authority is provided, comprising the steps of (a) preparing a machine-readable digital file of the OA; (b) preparing a machine-readable digital file of a first reference document alleged in a statement in the OA to have a portion teaching or suggesting a limitation in a claim under examination; (c) linking a word or phrase in the statement in the OA to the portion of the first reference document alleged in the statement to teach or suggest the limitation; (d) providing the machine-readable digital file and the first reference document in a package to a user; (e) displaying by the user the OA from the package in a first window on a display monitor coupled to a computerized appliance; and (f) activating the link by the user, displaying the first reference document at or near the portion alleged as teaching the limitation.

In one embodiment of the method, in steps (e) and (f), the OA is displayed in a first window and the first reference document is displayed in a separate, second window, such that the first window remains open displaying the OA when the link is initiated displaying the first reference document in the separate, second window. Also in one embodiment the OA comprises multiple statements alleging a portion of the first reference document as teaching or suggesting different limitations in one or more claims in examination in the case, and hyperlinks from portions of different ones of the multiple statements to the portions of the first reference document alleged as teaching or suggesting a limitation. Still in an embodiment the OA comprises multiple statements alleging a portion of the first reference document and portions of one or more second reference documents as teaching or suggesting different limitations in one or more claims in examination in the case, and hyperlinks from portions of different ones of the multiple statements to the portions of the reference documents alleged as teaching or suggesting a limitation.

In some embodiments there is a text-editable document having a list of the claims in examination, the claims editable to amend the language recited in the claims, and portions of the document indicated for a user to compose responses to the allegations in the OA. The text-editable document may include a heading page stating at least the Case Serial Number, an examiner, and the art unit. In many embodiments the OA is issued by the United States Patent and Trademark Office.

### BRIEF DESCRIPTION OF THE SEVERAL VIEWS OF THE DRAWINGS

FIG. 1 is an illustration of a title page of an OA issued by the USPTO in a US patent case pending at the time of the present patent application.

FIG. 2 is an illustration of a page of the OA of FIG. 1 in which a rejection of a claim under 35 USC 103(a) is stated over a primary and two secondary references.

FIG. 3 is an illustration of an accelerator PAC folder according to an embodiment of the present invention.

FIG. 4 illustrates a first page of a Response document in the present example.

FIG. 5 is page 2 of the Response document in the present example.

FIG. 6 is page 3 of the Response document in the present example.

FIG. 7 is page 9 of the Response document in the present example.

FIG. 8 is an illustration of page 2 of the last previous response filed in the present example.

FIG. 9 illustrates a summary cover page of the enhanced action document in the Accelerator PAC according to an embodiment of the present invention.

FIG. 10 shows the list of references cited in this action.

FIG. 11 shows a portion of page 2 of the enhanced action document centered on the first issue raised by the examiner in the action.

FIG. 12 shows a first page of a standing claims document in an embodiment of the invention.

FIG. 13 illustrates page 3 of the action control document in an embodiment of the invention.

FIG. 14 illustrates the reference Huber opened to paragraph 50 in an embodiment of the invention.

### DETAILED DESCRIPTION OF THE INVENTION

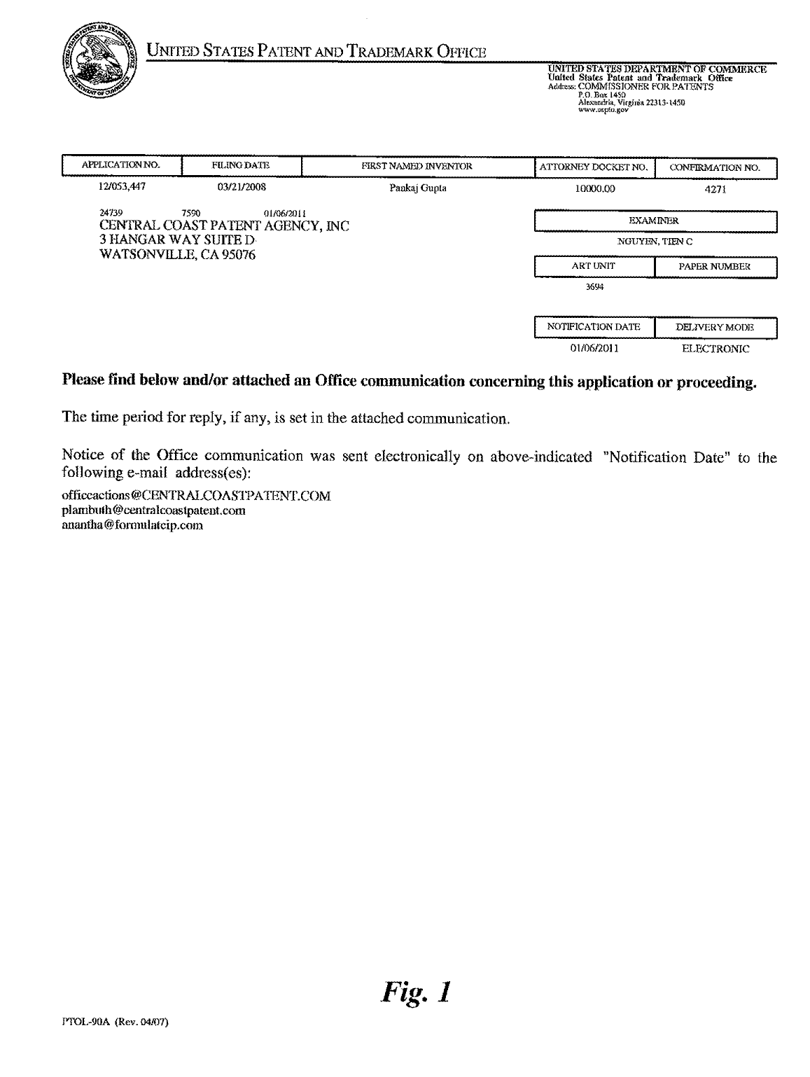

FIG. 1 is an illustration of a title page of an OA issued by the USPTO in a patent case pending at the time of filing the present patent application. As may be seen from this title page, the particular case is Ser. No. 12/053,447, filed on Mar. 21, 2008. The Examiner is Tien C. Nguyen of Art Unit 3694 of the USPTO, and the notification date is Jan. 6, 2011. The inventor is Pankaj Gupta, and the correspondence address is Central Coast Patent Agency, Inc. at #3 Hangar Way, Suite D, Watsonville, Calif. This application is a current pending application at the time of filing the present patent application, and is a published application, therefore in the public domain.

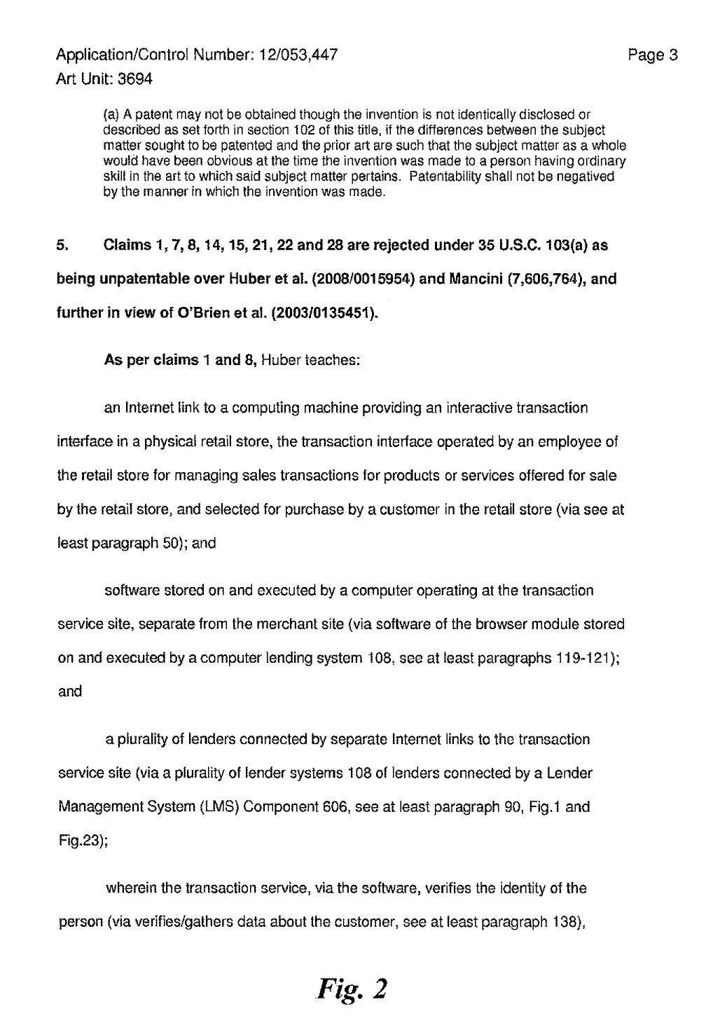

FIG. 2 is an illustration of a page of the OA of FIG. 1 in which a rejection of a claim under 35 USC 103(a) is stated over a primary and two secondary references. A general statement of the rejection is provided in bold in the first part of numbered section 5. The general statement states that “Claims 1, 7, 8, 14, 15, 21, 22 and 28 are rejected under 35 U.S.C. 103(a) as unpatentable over Huber et al. (2008/0015954) and Mancini (U.S. Pat. No. 7,606,764), and further in view of O'Brien et al. (2003/0135451). As will be apparent to the skilled person, Huber and O'Brien are published applications, and Mancini is an issued US Patent.

As will also be apparent to the skilled person, the 103(a) rejection raised by the examiner is but one of several issues raised by the examiner in the action. Further it is unusual for an office action to be limited to a single issue, and typically at least several issues are raised.

Of all cases filed in the USPTO, a relatively small percentage are filed pro se, that is, without benefit of counsel. It is far more common for an inventor or joint inventors, or for an owner of an application, to retain a patent law firm or an independent practitioner registered with the USPTO to represent that inventor or application owner in dealing with the USPTO. The practitioner or law firm is indicated in an issued action (see FIG. 1) as the correspondence address. In the action illustrated by FIG. 1 the firm is Central Coast Patent Agency.

Given an outstanding action it becomes a responsibility of the firm retained or the inventor or one of the joint inventors to respond to the OA. If the examiner has found dead-on prior art and made a good case for unpatentability of all the claims, and potentially any other claims the applicant might enter, the best response may be to abandon the case. More usually, however, the owner or owners of the application will want to keep the case alive with a response, and try to present one or more patentable claims and make a convincing case for patentability to the examiner.

A motivation for the present invention is that making the necessary decisions, planning a strategy, and then preparing a good response to an OA is far from a trivial pursuit. There will typically be many tasks to perform, many allegations to consider, many decisions to make, and a considerable amount of effort to be devoted to amending claims and authoring arguments in response to an examiner's allegations and reasoning in support of his or her allegations.

Consider, for example, that the OA itself is sent to the correspondence address as a hard-copy document, or may be downloaded as a PDF image file from the PAIR system database at the USPTO website. Firstly, a practitioner ultimately responsible for a response may want to include portions of comments made by the examiner in a response. To do this, someone has to render the text of the OA machine-readable, then someone has to decide which portions to put in a response document, block copy and paste portions into the response document, then reformat the pasted content to proper font and carriage returns.

Further to the above, the OA, as is seen in this example, refers to claim language that the applicant made in the original patent application, but does not present the claims as they stand. The OA also refers, sometimes obliquely, to portions of prior art references discovered in the search, and none of the references are provided in or with the OA; just a listing of the references, and comments about the references. To understand and deal with the examiner's allegations regarding the claims and portions of the references it is imperative that the standing claims and the references be found and made available to the practitioner preparing the response.

Still further to the above, a practitioner, to decide on claim amendments, may need to refer to the originally-filed specification and drawings, and will most definitely want to review the last response made, if there was one, to see what arguments were previously made and what rationale was used to respond previously. So the originally filed specification, the original drawings, and any previous response will need to be found and provided, and made immediately available to the practitioner as well.

Now, referring to FIG. 2, attention is directed to the first two full paragraphs after the general statement of the 103(a) rejection described above. These paragraphs state:

“As per claims 1 and 8, Huber teaches:

An Internet link to a computing machine providing an interactive transaction interface in a physical retail store, the interface operated by an employee of the retail store for managing sales transactions for products or services offered for sale by the retail store, and selected for purchase by a customer in the retail store (via see at least paragraph 50); and

Software stored on and executed by a computer operating at the transaction service site, separate from the merchant site (via software of the browser module stored on and executed by a computer lending system 108; see at least paragraphs 119-121; and”

The examiner in these paragraphs alleges that certain limitations of claims 1 and 8 are taught in the art by reference Huber at the paragraphs indicated. For the practitioner responsible for the response these allegations cannot be taken at face value. They must be carefully checked against the language of the claims, the precise language of the reference, and the context of the reference. The issue is whether (or not) the rejection is valid and correct. If not, the rejection should not stand, and the examiner should remove or change the rejection. It is incumbent on the practitioner to decide if the rejection should stand under the law, and if it should not, to make the best case possible to persuade the examiner of the error(s), and to convince the examiner to drop the rejection.

The present invention is not concerned with whether an examiner is correct, but only with providing all of the pertinent information to a practitioner in a way that the practitioner may quickly and effectively analyze the rejection and determine and carry out a plan in response. To do so the examiner typically has to (1) review the examiner's allegation, (2) review the claim language, and (3) review the exact portion of the reference applied by the examiner. The information needed by the practitioner in this example to do her job is in three separate digital files, and a fourth digital file (a Response document, typically an MS Word™ doc.) is needed for the practitioner to carry out her plan after reviewing the rejection and support for the rejection.

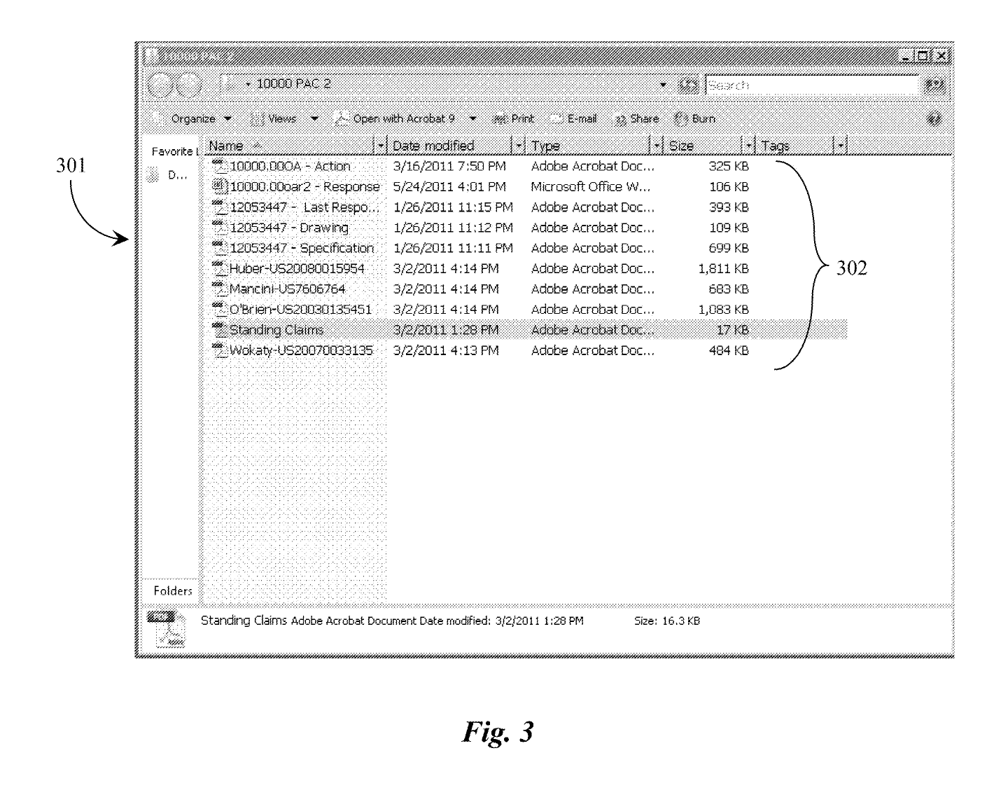

The present invention in a preferred embodiment is a package of files (folder 301; FIG. 3), termed an Accelerator Pac by the inventor, the files associated with one another and linked in a way that a practitioner may quickly and without frustration look at exactly what he or she needs in the order he or she needs to see it to do what must be done.

There are ten digital files in the PAC of FIG. 3 as follows:
Action
Response
Last response
Drawings
Specification
Huber
Mancini
O'Brien
Wokaty
Standing claims

The Action document in an embodiment of the invention is a specialized control document, and is described in detail below, after describing the other documents in the PAC.

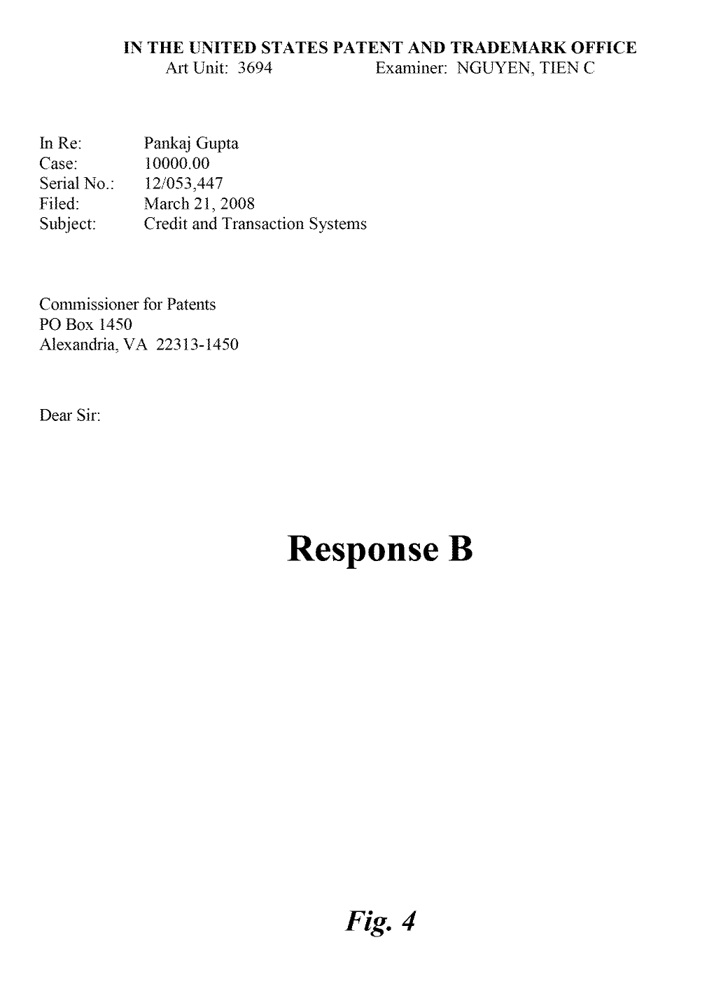

Response is a Word™ document prepared as a skeleton for the practitioner using the PAC to amend claims, author arguments, and implement any other responses to the outstanding OA. FIG. 4 illustrates the first page of the Response doc in the PAC in this example. The first page is a “cover” page, which states the demographics of the case, such as the Art Unit, the examiner's name, the inventor or inventors, the docket number (which is a number assigned by the applicant for identification, not by the USPTO), the Serial Number (assigned by the USPTO), the filing date, and the Title. It also addresses the response to the Commissioner of Patents at a P.O. Box in Alexandria, Va., and provides a salutation. The Title “Response B” is an identification by the law firm responding, in this case the Central Coast Patent Agency. This format is peculiar to Central Coast Patent Agency, and is just a preferred format for that firm. The information to be provided on the first page follows requirements of the USPTO, but the format is a matter of choice. Other firms follow a completely different format.

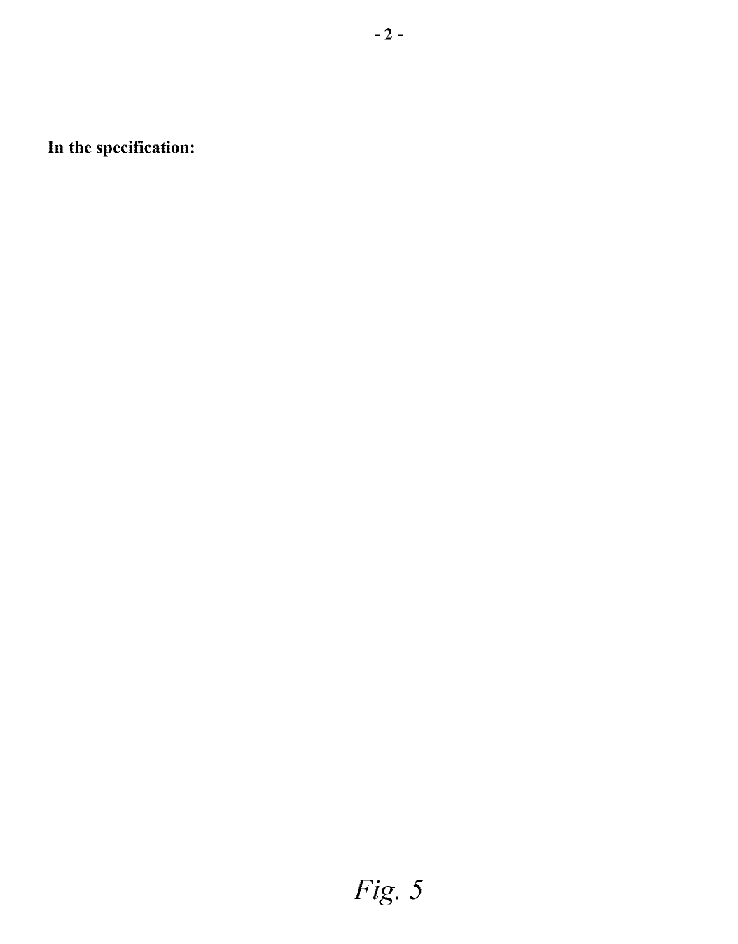

FIG. 5 illustrates the second page of the Response doc. The second page provides a place for the practitioner to present any modifications to the specification he or she might wish to make in response to the outstanding action. If there are no such modifications to be made the practitioner may simply indicate this fact, or may choose to delete the reference to the specification entirely. The dedication on page 2 is to give the practitioner the choice. The practitioner who uses the Accelerator PAC may of course alter and shape the Response in any way he or she might choose.

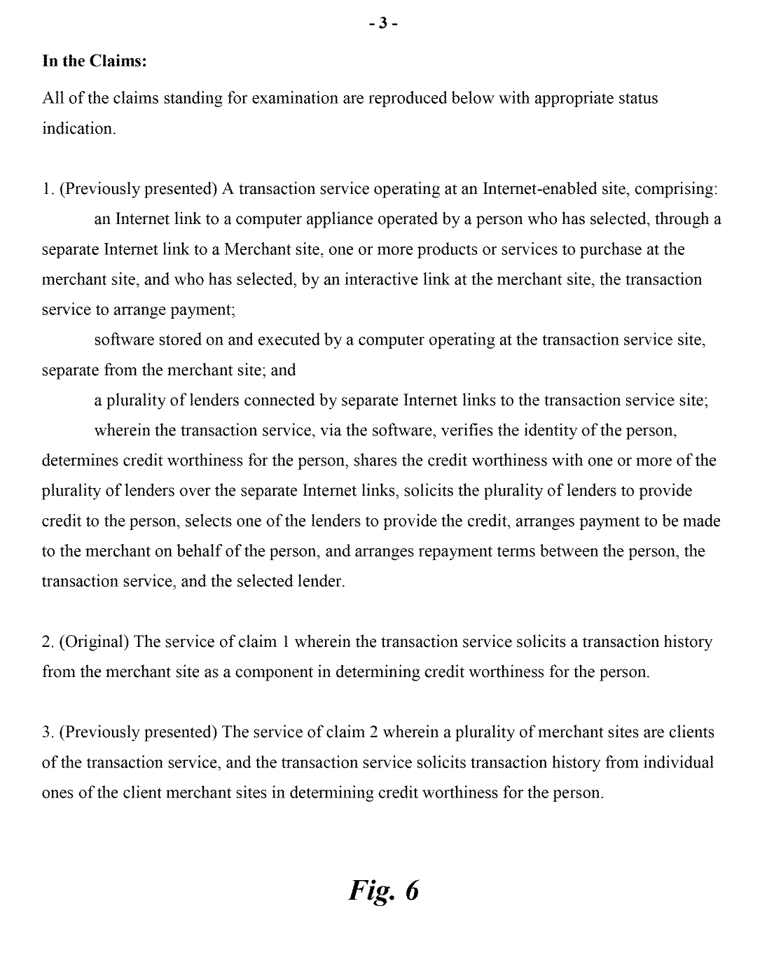

FIG. 6 illustrates page 3 of the Response document before the practitioner makes changes. This is a very important portion of the Response document. Beginning on page 3 the currently standing claims are listed. Currently standing means that if there was a prior amendment changing the language of any claims, which the skilled person will understand involves striking through language to be deleted and underling language to be added, the language with strikethrough has to be deleted and the underlines removed from the added language to show each claim “as amended”.

Further to the above, in a proper response each claim must have a status indication in parentheses at the beginning of the preamble of the claim. For a claim that has not been changed the status is (Original). For a claim that has been updated from an amended form, the status id (Previously presented). These are the only two status indications that will be used in the skeleton response document, because all of the claims will be listed before any further changes are made by the practitioner in finishing the response. If there was no prior response amending the claims, all of the claims will be the same as the originally filed specification, and the status will be original for every claim. In this example claims 1 and 3 were amended previously and updated, therefore the status is (Previously presented). Claim 2 was not changed before, therefore its status is (Original). The skilled person will realize that there may be several pages listing claims in the skeleton response document, but the inventor believes the illustration provided is sufficient to describe the invention.

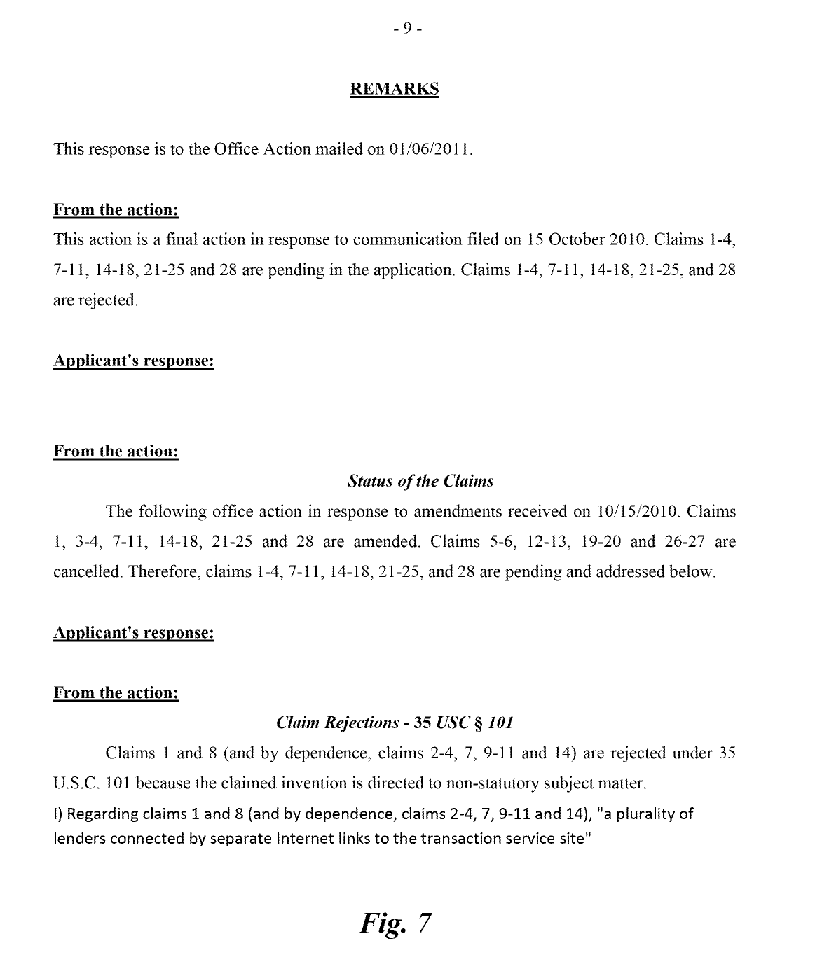

FIG. 7 illustrates page 9 of the skeleton Response document, which is the first page after the listing of the standing claims with status. This section is the “Remarks” section, and is the section where a practitioner will author his/her arguments in response to the examiner's allegations in the action. The first statement (issue) here is that this response is to the action mailed on Jan. 6, 2011.

In every action an examiner raises one or more issues, typically several. In the present action the second issue raised declares that the action is in response to the communication filed on 15 Oct. 2010. It happens that that communication was the previous response to an OA. Then it states the claims that are standing and that they are all rejected.

The skeleton response document is designed to list each issue raised by the examiner in order, and then to leave space just after each issue for the practitioner to author his or her response to the issue. The issues are copied directly from the action, in order, with font and formatting corrected.

The next (third) issue from the action is a statement of the status of the claims. A practitioner will typically not need to author a response with arguments to any of these three statements, but it pays to check everything an examiner says in an action. Sometimes an examiner is under time pressure or some other pressure, and may be mistaken in one or more such statements, and the practitioner will need to correct the record. For statements such as these first three the practitioner may choose to enter “Acknowledges” as a response, to contend with the statement to correct the record, or perhaps to just delete one or more of the issues. This is entirely up to the practitioner, and the design of the document is to (1) be sure every issue is considered, and (2) to leave the final format and all decisions to the practitioner.

The fourth issue raised is a first merit rejection of claims 1 and 8, and by association all claims depended from claims 1 and 8 under 35 U.S.C. 101, alleging that the claims are not directed to patentable subject matter. All of the statement and rationale by the examiner is not contained in page 9, but continues on page 10, and several other issues that are merit rejections follow, although are not shown here. The purpose here is to illustrate the essential nature of the editable skeleton response document that is included in the Accelerator PAC, which is (1) a listing of all of the standing claims, allowing a practitioner to amend as necessary, and a listing of each and every issue raised by the examiner, with a section following each for the practitioner to deal with the allegations and rationale of the examiner.

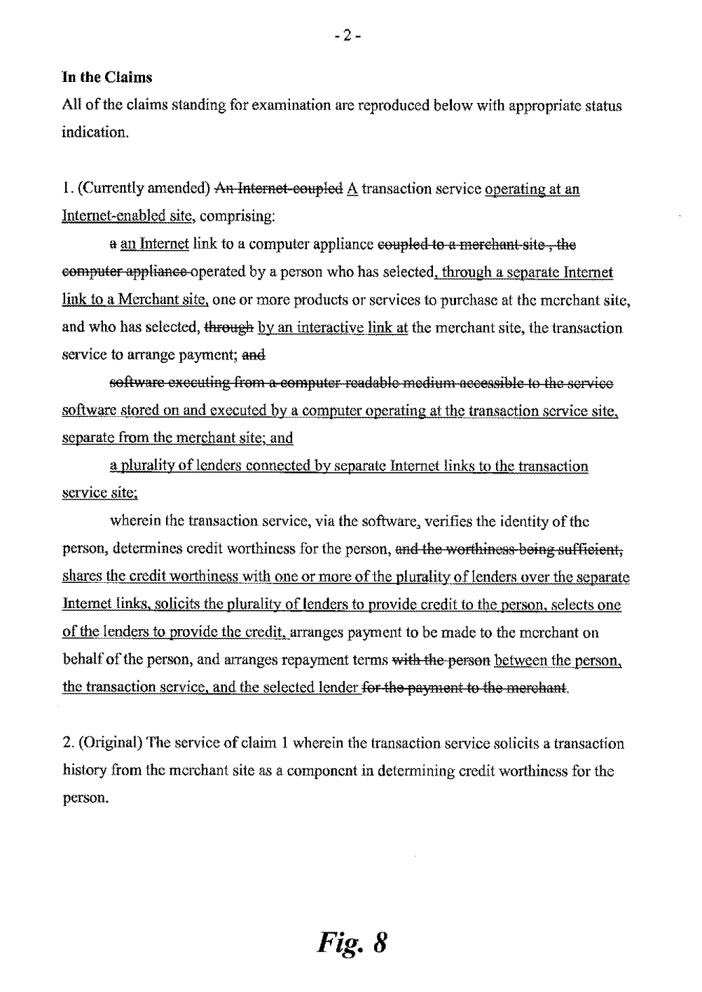

“Last Response” in the Accelerator PAC is a PDF copy, made machine-readable, of the immediate last response, if there is in fact one to present. In this example there is. FIG. 8 shows page 2 of that last response, which begins to list the claims. Attention is drawn to the fact that claim 1 is marked with status “Currently amended”, and shows strikethrough text and underlined text to indicate the changes the practitioner made in that previous response. The skilled person will realize that there may be more pages of claims. This last response, in addition to showing how claims were amended, if indeed they were, also has a “Remarks” section with the practitioner's responses to each issue raised by the examiner in the previous OA. This information will be valuable to the practitioner in determining a strategy for the present response. This “last response” is the source of the standing claims for the new skeleton “response document”. For the new document the strikethrough text is deleted and the underlines removed to show the claims as the currently stand, and the status indications are updated.

Drawings and Specification in the Accelerator PAC are the latest form of the drawings, if the drawings have been changed in the prosecution of the case thus far, or the as-filed drawings in the case if not. The specification is the as-filed specification. Both are PDF documents, and both are drawn from Public PAIR for a published case. The specification is rendered machine-readable.

There are four references applied by the examiner in the Accelerator PAC of the invention in this particular embodiment, these being Huber, Mancini, O'Brien and Wokaty. These references are typically stored and retrieved by serial number, if they are in fact US patents, but examiners always refer to the references by the first inventor's names. It is therefore better for the practitioner who uses the Accelerator PAC if the references are renamed to the first inventor's names. The applied references are retrieved from any one of several sources by serial number, typically as PDF image files, are rendered machine readable, and saved with the inventor's name as the file name in the Accelerator PAC. The skilled person is very familiar with the form of such references and none are needed to be shown here.

A file named “Standing claims” is included in the Accelerator PAC as well, and is prepared as a machine-readable PDF file showing all of the claims as last amended and “normalized” just as they appear in the listing at the beginning of the skeleton response document. The purpose of this file will be apparent in further description below.

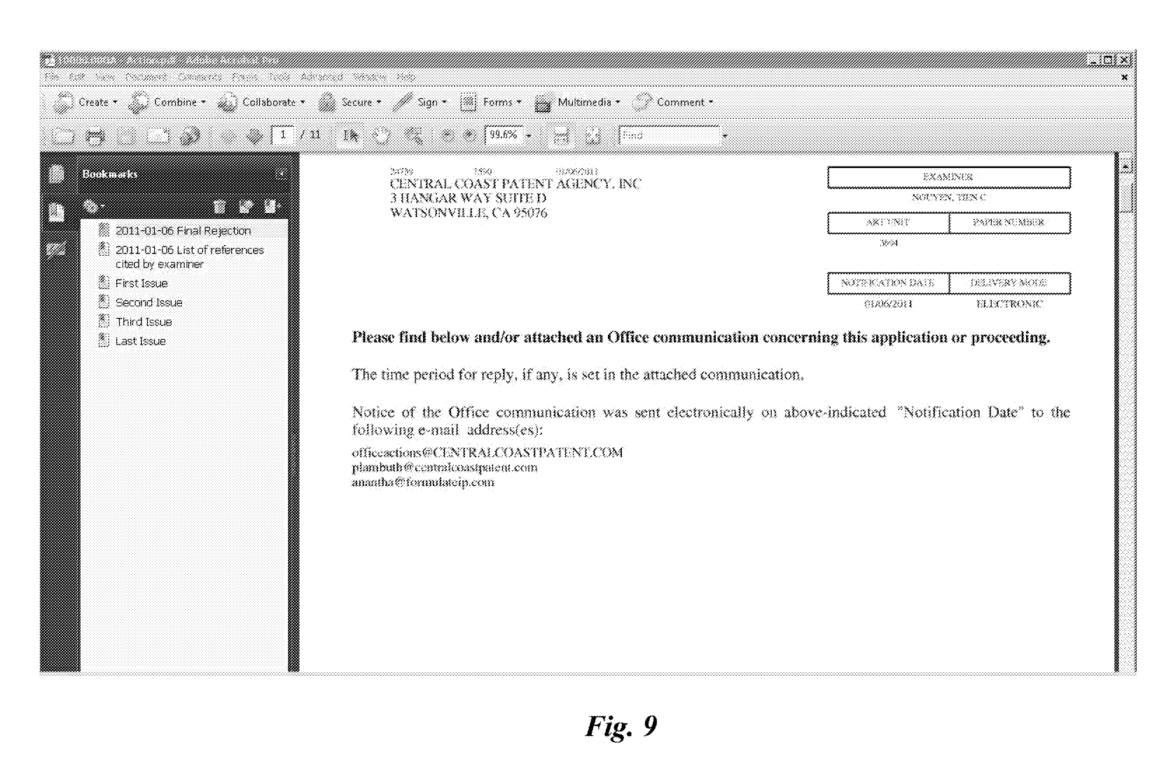

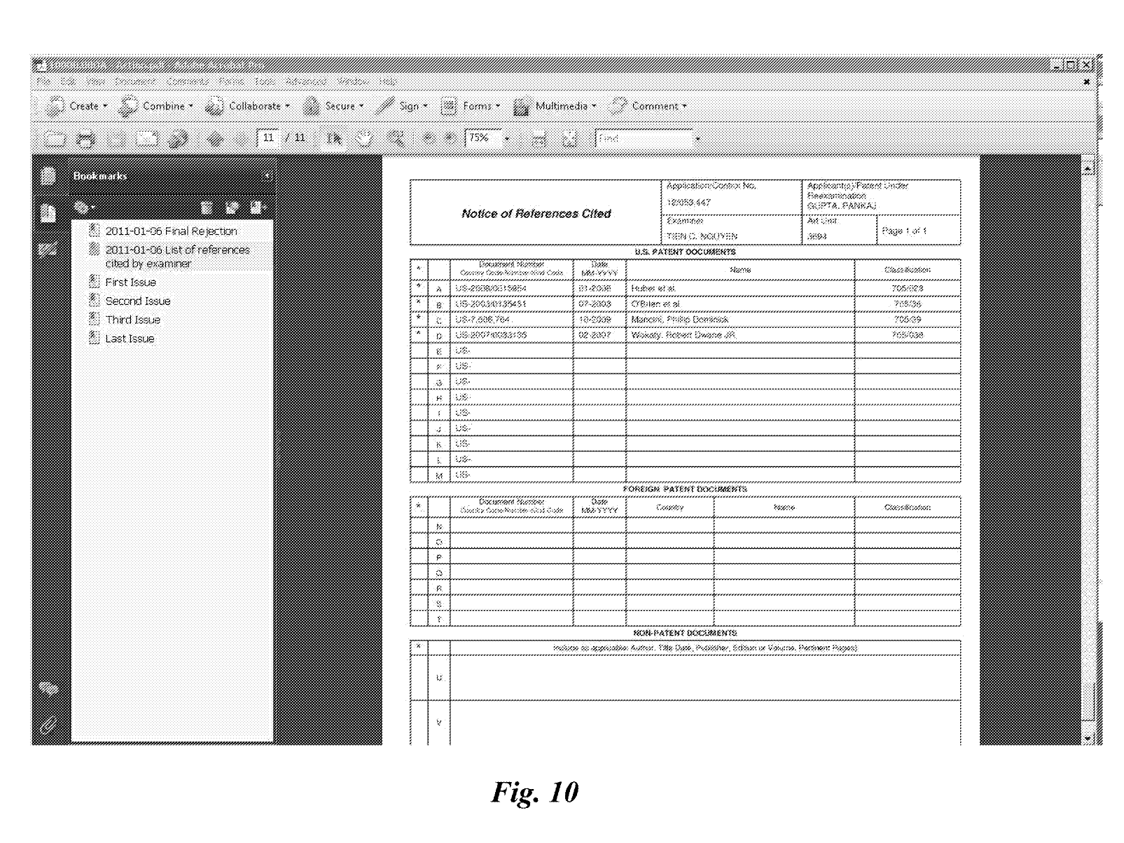

Attention is directed now to the Action document in the Accelerator PAC. This is the action issued by the USPTO, derived from Public PAIR, and enhanced as a control document to provide special navigation features to make the practitioner's task as focused as possible. FIG. 9 illustrates the top of the first page, which is a summary cover page of the enhanced action document in the Accelerator PAC according to an embodiment of the present invention. The document is an Acrobat PDF™ document, and is shown with the “Bookmarks” panel open. Bookmarks have been created for the cover page shown, and for, in order, a list of references cited by the examiner, a first issue raised by the examiner, a second issue, a third issue and a last issue; four issues in all. FIG. 10 shows the list of references cited in this action (there may have been other references cited in previous actions), as a user will see by selecting the appropriate bookmark, or by scrolling to the last page of the action.

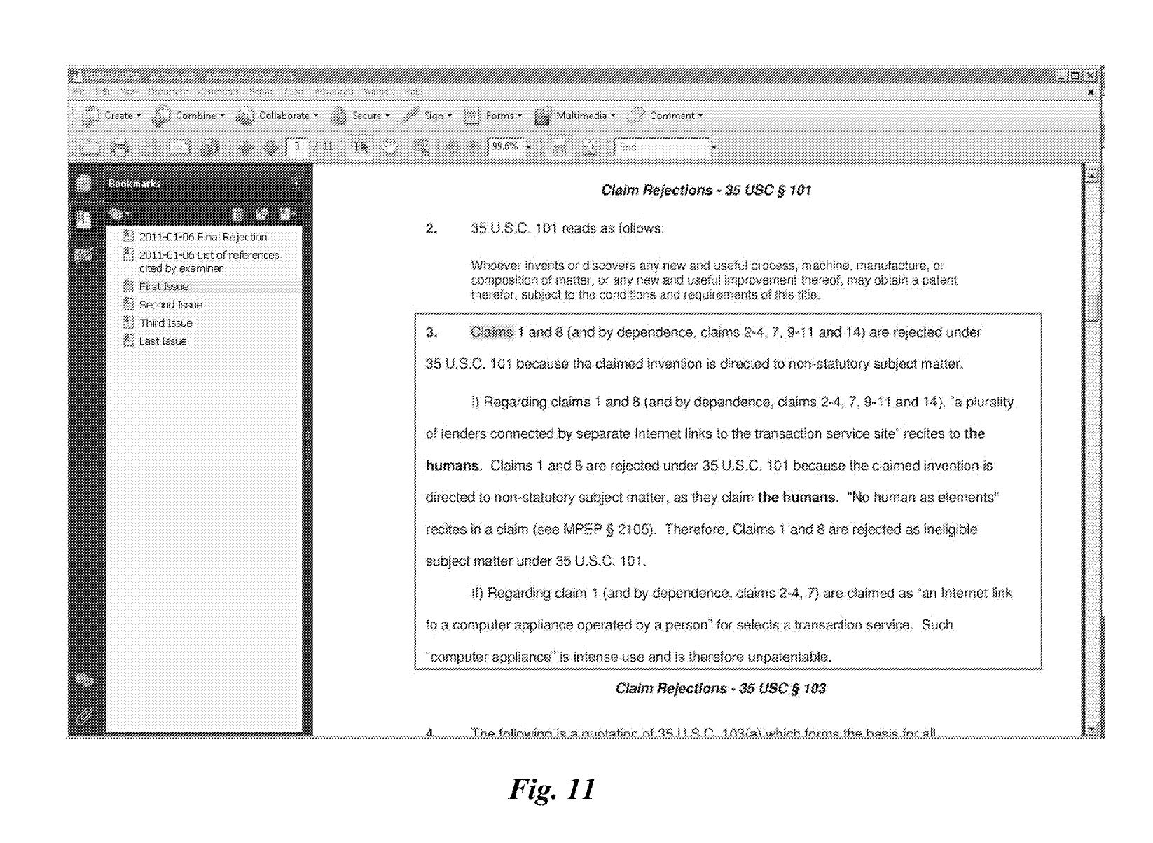

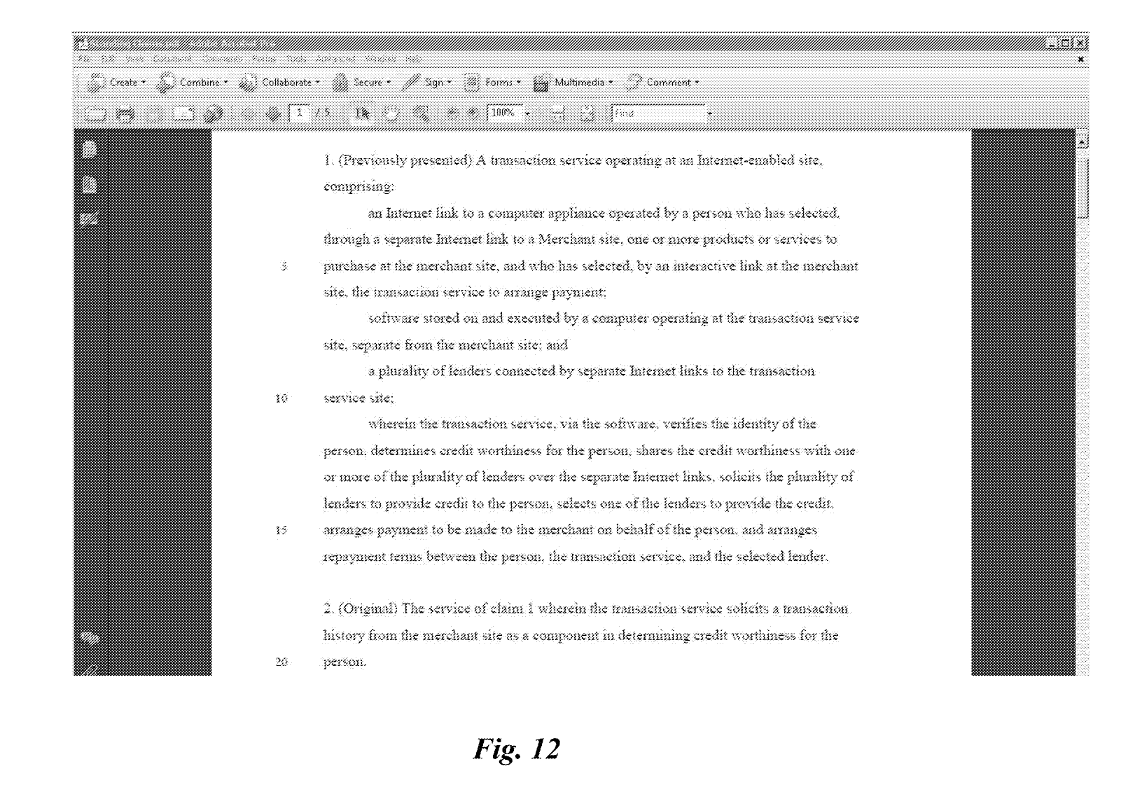

FIG. 11 shows a portion of page 2 of the enhanced action document centered on the first issue raised by the examiner in the action, which is a rejection under 35 U.S.C. 101, alleging that claims 1 and 8, and the claims depended therefrom, do not recite patentable subject matter. The statement of the rejection and the rationale supporting the rejection is surrounded by a red border in this example, to mark off the statement of the issue in the action. Note that the word “claims” is highlighted in pale yellow. This indicates a hyperlink that has been implemented in the document. To determine whether the examiner's allegations of unpatentablility are correct it is necessary that the practitioner read the language of especially claims 1 and 8, and analyze the examiner's comments in context of the actual claim language. The link from “Claims” opens the document “Standing Claims” in the PAC at claim 1 (See FIG. 12). The practitioner can scroll the claims document to claim 8 and other claims if desired. This association of issues and allegations in the action to the standing claims allows the practitioner to quickly make a decision whether the examiner is correct or even partially so, and to decide whether to amend the claims or just to author arguments disputing the examiner's allegations. The practitioner does not have to “go find” the claims, or open, close and reopen documents.

The skilled person will understand that indicating an issue with a border, and the use of pale yellow highlighting to indicate links is a preference, and could be done differently according to a practitioners preference.

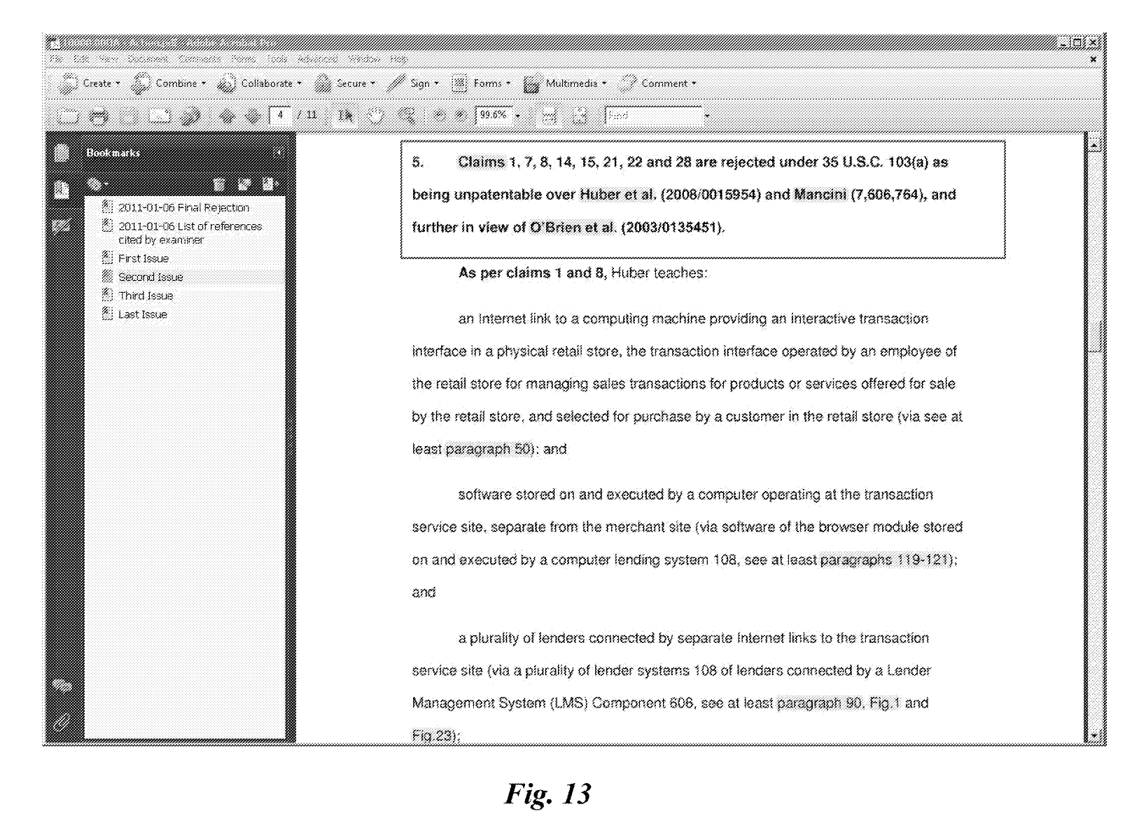

FIG. 13 illustrates page 3 of the action control document showing the second issue and links associated with the second issue. Again, the general statement of the second issue in the action, which is a 103(a) rejection over three references, is given a red border. The practitioner can scroll to the issue, or use the bookmarks provided for that purpose.

Several links are implemented in the general statement of the second issue for convenience of the practitioner. One is from the word “Claims”, which links to the beginning of the “Standing claims” document in the Accelerator pack. Additionally each of the three references alluded to in the general statement of the rejection are linked from the inventor's name associated with the reference (Huber, Mancini, O'Brien) to the beginning of the particular reference. This allows the practitioner to jump immediately to each of the references to review, for example, the Abstract of each reference, or to look more closely if the practitioner desires.

In the first issue described above the rejection was a 101 rejection, and there was no prior art reference associated with the rejection. Therefore there were no specific applications of prior art. In the second issue, however, there are several applications of prior art to different portions (limitations) of one or more standing claims. These are stated after the general statement of the rejection, which is bordered, and before the next general statement of a rejection, which in this example is stated on page 5 of the action. Only a portion of page 4 is shown in FIG. 13, but the inventor believes this will be enough to sufficiently describe the invention to support the claims.

Attention is drawn in FIG. 13 to the first paragraph following the general statement of the second issue in the action. The examiner in this paragraph recites a limitation ostensibly from claims 1 and 8, and at the end of the paragraph states: (via see at least paragraph 50). The paragraph 50 indication is for reference Huber. In the action control document the phrase “paragraph 50” is linked to the Huber reference, to open the reference at the page showing paragraph 50, and to open the Huber reference in a separate window, so the action document remains open in the window in which it currently displayed.

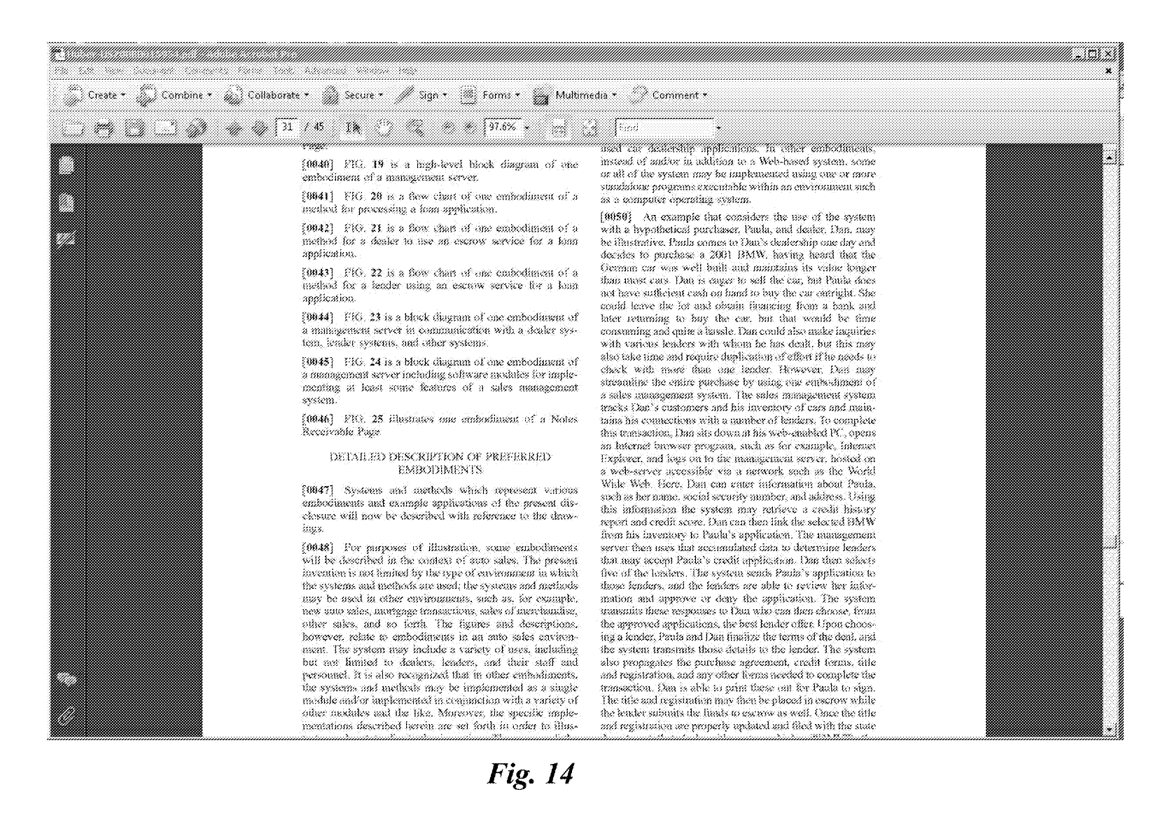

FIG. 14 illustrates the reference Huber opened to paragraph 50. In some embodiments paragraph 50 may be highlighted. In some embodiments just the number 50 may be highlighted. In some embodiments there are no highlights. But in any case, activation of the link to Huber paragraph 50 opens Huber to paragraph 50 in a window separate from the window showing the action control document.

The practitioner's task is to fully evaluate the examiner's allegation and rationale in rejection. To do so the practitioner needs to look at the actual claims 1 and 8 to be sure the examiner did not, inadvertently or otherwise, change the statement of the limitation somewhat. The practitioner can do this activating the “claims” link above in the general statement, which opens the claims document also in a separate window. Now the practitioner can easily move among the three pertinent documents to fully evaluate the rejection, and to decide on what to do about it.

An important purpose of the invention is to make the necessary information immediately available to the practitioner, allowing the practitioner to move smoothly between different documents without having to find, open, and scroll through the documents. There is no effort to make or suggest any decision, solution or strategy to the practitioner. The practitioner is the experienced and knowledgeable person, and the invention in this embodiment allows the practitioner to apply that experience and knowledge quickly and directly without being burdened with searching for documents, and scrolling within documents found and opened.

Similar implementation of links has been implemented in the remainder of the action control document, so the practitioner may visit each issue raised by the examiner in order, or out of order if the practitioner chooses, evaluate the allegations and applications of art, and make decisions and determine strategy.

Attention is drawn to FIGS. 4-8 and associated description above, which describes the skeleton Response document provided in the Accelerator Pack. At any point in the process the practitioner may open and work in this document. For example, if the practitioner determines in review of the first issue that an amendment to one or more claims is necessary to resolve the 101 rejection alleging one or more claims are “non-statutory”, the examiner may go to the claims section of the Response document, make the appropriate amendments, update the claims status, and then move to the “Remarks” section and author the applicant's response to the rejection made by the examiner.

Some practitioners are OK with having the full statement of the rejections “from the action” stated in the Remarks portion of the response. Some are not. But having it there in the beginning allows the practitioner to have the examiner's allegation in view while authoring the response. The practitioner may then easily delete the “from the action” statement.

Alternatively to authoring the response to each issue in order after due consideration, a practitioner may make notes and do all of the response in one swoop. The invention makes no limitation as to the task flow of the practitioner, who is the person most qualified to make that determination.

In another aspect of the invention an Internet-hosted portal is provided allowing both clients who wish to take advantage of Accelerator Packs for Patent prosecution and builders who are trained and experienced in building and testing Accelerator Packs to interface to make Accelerator Packs available to a wide range of inventors, independent registered practitioners and law firms employing one or more registered patent practitioners. In this application illustrations of interactive interfaces provided by the portal are not provided, but are described in some detail.

On an entry page for the portal there is a link labeled “Log In”. Clients, builders, managers, and other knowledge workers of various sorts each are enabled with a username and password for secure log in. Different persons, each identified by their log in and stored profile information, is enabled to access particular pages and functions in the portal, and not allowed access to others.

Consider now one independent practitioner that has acquired client status. When this practitioner logs in, he or she will see a page listing all jobs in the portal that are jobs he or she has authorized. In a plurality of columns in the list the jobs are indicated as to status, such as “requested”, “build”, “pay” and “complete”. In a left margin a menu provides a link to “New Job”. The client may select this link, and will get a form in a window to fill out to enter a new job. That form allows the client to select a firm name (if any), a prosecutor's name, allowing an administrator for a firm to assign new Packs to particular prosecutors (practitioners in the firm), to assign a “tracking number” which may be a number particular to a practitioner or firm for internal tracking and management, a Serial Number, which in the example given is the Serial Number assigned to the case by the USPTO, an OA number, such a 1, 2, 3, to indicate how many actions there have been in the instant case, and a place for notes that the person entering the new job may post. The notes might indicate, for example, that the practitioner has a special requirement for quick turnaround in the newly entered case.

The new job form in this example has a “save” button and a “cancel” button. When the entering practitioner selects “save” the job is entered in the portal. Once entered, the new job will appear on the client's list with all of the columns filled in, and with a status as “requested”. The new job will now also appear on a specialists list as requested. The specialist is a knowledge worker associated with the host of the portal whose task it is to review the new job, and offer or assign it to a builder. A builder logging in gets a listing of all current jobs that builder has accepted, the time to finish the requested Pack, and any new jobs offered.

Once assigned, the builder to which the job is assigned retrieves all the necessary documents from an appropriate source, processes the documents to render image documents as machine-readable, for example, builds the action control document from the action document issued by the USPTO, builds the skeleton response document, builds all other documents as needed, places all in the folder for the Pack, and uploads the newly created Pack to the portal. This upload triggers a quality assurance process in which the new Pack is reviewed by one or more experienced builders or checkers. Finally the new Pack is listed as “built” for the client, who may then download the Pack. Then status changes to pay until the Pack is paid for, then to complete. An extensive database backs up the portal.

In embodiments described above an Accelerator Pack is described as a folder containing digital files that are assembled and processed by builders to have the associations between files that provides the navigation ability for a client (user) to download from the portal and then use to prepare a response to an OA. In a broader sense a collection of files in a folder that a client may download and use is just one way to render the Accelerator Pack.

In another embodiment of the invention much more may be done on-line than described in embodiments above. For example, the portal, once a Pack is authorized by a client, by virtue of software executed by one or more servers comprising the portal, might connect to on-line sources, such as the USPTO Public PAIR dB and Pat2PDF, for example, and extract all the needed digital files for the Accelerator Pack. Further by means of software the portal might process the files acquired for the Pack to a form suitable for the Pack functionality and create links and markups in displays of the files to provide displaying all of the information the practitioner will need to author the response. In such embodiments the links and markup would really be meta-data that stored in data storage facilities at the portal. With a completed Pack the portal would provide an interactive interface to the client to activate the links, review the examiner's allegations, the standing claims and the references cited and applied, and prepare the response.

In these more fully-automated forms of an Accelerator Pack the data and associations, as well as client interface, might be done in any one of several known formats, such as PDF, a specialized application, an eBook, or entirely web-based as described above. In these formats, when a client determines to consume a finished Accelerator Pack, the portal interface provides a selection to the client (Web, PDF, App, eBook) and the portal provides an appropriate interface or data set to operate the Pack to accomplish the necessary task flow to make the decisions, amendments to claims, and authored arguments to complete the response. Authoring the response might be done in an app which outputs a PDF file in USPTO format. In some cases the portal might accomplish the filing (eFile) of the response with the USPTO (or other patent jurisdiction).

It will be apparent to the skilled person that there are many changes that might be made in the exampled described above without changing the essential nature of the invention. Links in the control document might be indicated in a variety of different ways for example. Applied portions of references may be highlighted or not. A variety of different formats may be used for a skeleton response document. In some embodiments a response document is not provided, because a client prefers to make it. There are many such alterations that might be made. The scope of the invention is limited only by the claims that follow.

1. A package of digital files for patent prosecution, the package resident on a memory device coupled to a computerized appliance, the package comprising:
an office action (OA) issued by a patent examination authority, the OA dedicated to a specific case in examination by the patent examination authority, the OA implemented as a machine-readable digital file displayable in a window on a display monitor coupled to the computerized appliance; and
a first reference document implemented as a machine-readable digital file also displayable in the same or a separate window on the display monitor;
wherein the OA comprises a statement alleging a portion of the first reference document as teaching or suggesting a limitation of a claim in examination in the specific case, and a word or phrase in the statement is implemented as a hyperlink to the portion of the first reference document alleged as teaching or suggesting the limitation of the claim, such that activating the link in a window on the display monitor displays the first reference document at a place at or near the portion alleged as teaching the limitation.

2. The package of claim 1 wherein the OA is displayed in a first window and the first reference document is displayed in a separate, second window, such that the first window remains open displaying the OA when the link is initiated displaying the first reference document in the separate, second window.

3. The package of claim 1 wherein the OA comprises multiple statements alleging a portion of the first reference document as teaching or suggesting different limitations in one or more claims in examination in the case, and hyperlinks from portions of different ones of the multiple statements to the portions of the first reference document alleged as teaching or suggesting a limitation.

4. The package of claim 1 wherein the OA comprises multiple statements alleging a portion of the first reference document and portions of one or more second reference documents as teaching or suggesting different limitations in one or more claims in examination in the case, and hyperlinks from portions of different ones of the multiple statements to the portions of the reference documents alleged as teaching or suggesting a limitation.

5. The package of claim 1 further comprising a text-editable document having a list of the claims in examination, the claims editable to amend the language recited in the claims, and portions of the document indicated for a user to compose responses to the allegations in the OA.

6. The package of claim 5 wherein the text-editable document comprises a heading page stating at least the Case Serial Number, an examiner, and the art unit.

7. The package of claim 1 wherein the OA is issued by the United States Patent and Trademark Office.

8. A method facilitating response to an Office Action (OA) issued by a patent examining authority in a specific case under examination by the authority, comprising the steps of:
(a) preparing a machine-readable digital file of the OA;
(b) preparing a machine-readable digital file of a first reference document alleged in a statement in the OA to have a portion teaching or suggesting a limitation in a claim under examination;
(c) linking a word or phrase in the statement in the OA to the portion of the first reference document alleged in the statement to teach or suggest the limitation;
(d) providing the machine-readable digital file and the first reference document in a package to a user;
(e) displaying by the user the OA from the package in a first window on a display monitor coupled to a computerized appliance; and
(f) activating the link by the user, displaying the first reference document at or near the portion alleged as teaching the limitation.

9. The method of claim 8 wherein, in steps (e) and (f), the OA is displayed in a first window and the first reference document is displayed in a separate, second window, such that the first window remains open displaying the OA when the link is initiated displaying the first reference document in the separate, second window.

10. The method of claim 8 wherein the OA comprises multiple statements alleging a portion of the first reference document as teaching or suggesting different limitations in one or more claims in examination in the case, and hyperlinks from portions of different ones of the multiple statements to the portions of the first reference document alleged as teaching or suggesting a limitation.

11. The method of claim 8 wherein the OA comprises multiple statements alleging a portion of the first reference document and portions of one or more second reference documents as teaching or suggesting different limitations in one or more claims in examination in the case, and hyperlinks from portions of different ones of the multiple statements to the portions of the reference documents alleged as teaching or suggesting a limitation.

12. The method of claim 8 further comprising a text-editable document having a list of the claims in examination, the claims editable to amend the language recited in the claims, and portions of the document indicated for a user to compose responses to the allegations in the OA.

13. The package of claim 12 wherein the text-editable document comprises a heading page stating at least the Case Serial Number, an examiner, and the art unit.

14. The method of claim 1 wherein the OA is issued by the United States Patent and Trademark Office.
